(19) United States
(12) Patent Application Publication
(10) Pub. No.: US 2011/0300034 A1
(43) Pub. Date: Dec. 8, 2011

(54) Disposable, High Pressure Microfluidic Chips

(75) Inventors: Dieudonne Mair, Santa Clara, CA (US); Emil J. Geiger, Oakland, CA (US)

(73) Assignee: The Regents of the University of California, Oakland, CA (US)

(21) Appl. No.: 12/304,902

(22) PCT Filed: Jun. 19, 2007
(86) PCT No.: PCT/US07/71607

§ 371 Date: May 5, 2009

Related U.S. Application Data
(60) Provisional application No. 60/805,155, filed on Jun. 19, 2006.

(51) Int. Cl. B01L 99/00; B29C 45/16

(52) U.S. Cl. 422/502; 156/245

(57) ABSTRACT

An injection molding process for the fabrication of disposable unitary plastic microfluidic chips with a cycle time on the order of minutes is described. The microfluidic chips feature novel, integrated, reversible, standardized, ready-to-use inter-connects that enable operation at pressures not before realized with microfluidic chips.

### CROSS-REFERENCE TO RELATED APPLICATIONS

This application claims priority to U.S. Provisional Patent Application 60/805,155 filed Jun. 19, 2006, which is incorporated by reference herein.

### STATEMENT OF GOVERNMENTAL SUPPORT

The invention described and claimed herein was made in part utilizing funds supplied by the U.S. Department of Energy under Contract No. DE-ACO3-76SF00098, and more recently under DE-ACO2-05CH11231. The government has certain rights in this invention.

### TECHNICAL FIELD

This invention relates generally to microfluidic devices, and, more specifically, to a microfluidic chip with integrated interconnects and a method of making same.

### BACKGROUND ART

Portable and self-contained point-of-care diagnostic tools are the promise of miniaturized biomedical analysis devices—microfluidics. Efforts to scale-down chemical analyses with microfluidic devices have been driven by the significant reduction in the volume of reagents and samples required for analysis as well as the acceleration of the process due to the shorter distances the samples have to traverse. Microfluidic chips have been fabricated from a variety of materials including silicon, fused silica, glass, quartz, and plastics. The chemistry of these substrates is well understood and most also have optical properties required for analysis by laser-induced fluorescence (LIF).

The first micro total analytical system (μTAS) was made from inorganic materials by adapting well-known micromachining processes developed for the fabrication of integrated circuits. However, fabrication is both slow and expensive, as it involves a multi-step process consisting of cleaning, photoresist deposition, lithography, and etching. Therefore, there has been interest in making a transition from conventional inorganic substrates to plastics, which could enable cost-effective and high-volume production of disposable microfluidic devices or chips. Today, the most common technologies for preparing microfluidic systems from plastics involve laser ablation, hot embossing, soft lithography, or injection molding. A wide variety of polymers such as polyimide, poly(methyl methacrylate), polycarbonate, polydimethylsiloxane, and polyolefins have been used. The choice of specific material has been determined by its physical and chemical properties as well as the technology used for fabrication.

An obstacle that currently impedes broader use of microfluidics is the lack of standard interconnects for interfacing the macroscale environment with microfluidic channels within a chip. The issue of convenience is especially important in high-throughput applications where the significant amount of time required to manipulate and attach several interconnects can offset the economic advantages of migrating to a microfluidic platform. Typically, capillaries, tubes, and pipette tips have been glued to fluid access holes in the chip. Unfortunately, this manual approach depends greatly on the skill of the operator and is not always reproducible. The failure of even a single interconnect can be detrimental to device operation, and repair is often not an option. Moreover, glue near the access holes can lead to chemical contamination. Multi-step interconnect fabrication techniques that eliminate contact between glue and working fluids, as well as glue-free methods, have been developed. But these newer techniques can be time consuming and expensive, and offer drawbacks of their own.

In order to realize the promise of microfluidics, a chip that can be manufactured quickly, cheaply, and is ready-to-use with no need for further assembly, is clearly needed. If such a chip can also be used reversibly and with high liquid pressures, even more microfluidic applications can be realized.

### DISCLOSURE OF INVENTION AND BEST MODE FOR CARRYING OUT THE INVENTION

An injection molding process for the fabrication of disposable unitary plastic microfluidic chips with a cycle time on the order of minutes is described in the embodiments of the invention herein. The microfluidic chips feature novel, integrated, reversible, standardized, ready-to-use interconnects that enable operation at pressures not before realized with microfluidic chips.

The microfluidic chip as described herein has integrated interconnects and offers many desirable benefits. Each individual port has a very small footprint, thus allowing a high density of fluidic I/O ports on a single chip. The ports are configured to have minimal dead volume, which allows more efficient use of analytes and less concern that important materials have gotten trapped in the port instead of flowing into the analytical portion of the chip. The chip with integrated interconnects is easy to use. There is no need to develop great skill in positioning and gluing ports onto a chip. And there is no worry about contaminating a sample with glue. There is no glue. The ports are already connected. The ports have a standard geometry to facilitate interfacing with commercially available devices. Furthermore, integrated ports are able to withstand much higher back pressures than glued on ports, making it possible to do analyses that could not be done before. And finally, microfluidic fluidic chips with integrated ports are easy and inexpensive to fabricate.

FIG. 1a shows a cross section view of a prior art microfluidic chip system 100 that is currently available. The system 100 includes a microfluidic chip 110 with a top portion 112 bonded to a bottom portion 114. There is a channel 113 that extends through the chip 110 and has openings 118 at the top surface 111. FIG. 1b shows a perspective view of an interconnect port 120 that is designed to attach to the top surface 111 at opening 118 in the chip 110. The port 120 has a hole 122 that extends from the top to the bottom 126 of the port 120. FIG. 1c shows a bottom view of the port 120. Around the hole 122, there is a washer 124 which is meant to prevent glue from reaching the hole 122 when the bottom surface 126 of the port 120 is glued to the top surface 111 of the chip 110. FIG. 1a shows two ports 120 attached to the top surface 111. The port holes 122 are aligned with the openings 118 in the top surface 111. Glue 130 forms a bond between the chip top surface 111 and the port bottom surfaces 126. Washers 124 prevent the glue 130 from encroaching into the openings 118. A fluid path 115 through the chip 110 is indicated by the dashed arrows. FIG. 1d is a top view of the microfluidic chip system 100.

There are many problems associated the system described in FIG. 1. Gluing the interconnect ports to the chip surface is non-trivial. It requires patience and knack. One must apply a sufficient amount of glue to ensure a strong bond, but not so much that the glue seeps near to or into the fluid opening. If the fluid being analyzed comes into contact with the glue, it can become contaminated, thereby voiding the analysis. It is important to have a strong bond to avoid having a port pop off during analysis. Pressure can build up as fluids are forced into the channel, and this can lead to bonding failure. If a port does pop off, the analysis may be finished, as it may not be possible to re-attach the port without introducing contamination. Furthermore, after gluing ports to a chip, it is often necessary to wait for several hours or even overnight before using the system in order to let the glue cure. Another disadvantage with this system is that the ports are bulky and they take up much more room on the chip surface than the fluid openings. Thus, the number of usable channels, and therefore the number of analyses that can be done on a chip is limited not so much by the chip itself, but rather by the number of ports that can be attached to the chip.

Packed beds are commonplace in large-scale industrial processes, yet the large surface area they impart has not been widely exploited in microfluidic applications. Microfluidic chips experience high back pressures in routine operation when the channels are filled with beads. At high pressures, microfluidic devices often fail at one of two junctions: either at the point of attachment of the interconnect (e.g., where port 120 is glued to surface 111 in FIG. 1a), or at the interface between the two bonded chip parts (e.g., top portion 112 and bottom portion 114 in FIG. 1a). The bond at the fluidic interconnect is typically weaker than the chip bond, so it would be useful to eliminate the interconnect junctions, which are so subject to failure. An added benefit could be derived by eliminating the extra fabrication steps required for attaching the interconnects. These benefits have been achieved by carefully designing a mold base to produce a part with female interconnect ports that are fully integrated into a microfluidic chip. As shown in the embodiment in FIG. 2, the upper part of chip features a hollow boss located at each fluid entry point.

FIG. 2a shows a longitudinal cross section view of a microfluidic chip system 200, according to an embodiment of the invention. The system 200 includes a microfluidic chip 210 with a top portion 212 and a bottom portion 214. The terms “top” and “bottom” are used in reference to the orientation of the microfluidic chip 210 shown in the figure and are not meant to suggest that the microfluidic chip 210 cannot be used in other orientations. There is no absolute “top” or “bottom” for the microfluidic chip 210. In some discussion of the embodiments for making microfluidic chips, the top piece 212 is referred to as the A-side, and the bottom piece 214 is referred to as the B-side. Interconnect ports 220 for the system 200 are not separate pieces, but are formed integrally with the top portion 212 of the chip 210. As used herein, ports formed “integrally” with the top portion means that the ports and the top portion form a unitary whole, i.e., the ports and the top portion are formed together as one piece. There is no need to attach any additional ports to the chip 210 to make it ready to use. Thus, the system 200 is a unitary interconnect/microfluidic chip system 200.

There is a fluid path 215 that extends from a first opening 222, through a channel 213 between the top portion 212 and the bottom portion 214 of the chip 210, and up through a second opening 224. The channel 213 is defined by a groove in the bottom surface 209 of the top portion 212 and by a (flat) top surface 208 of the bottom portion 214. In other arrangements (not shown), the channel 213 can be defined by a groove in the top surface 208 of the bottom portion 214 and a (flat) bottom surface 209 of the top portion 212. In yet other arrangements (not shown), the channel 213 can be defined by a groove in the bottom surface 209 of the top portion 212 aligned with a groove in the top surface 208 of the bottom portion 214.

FIG. 2b is a top view of the system of FIG. 2a. Lines c-c and d-d indicate where cuts were made for the transverse cross sections views shown in FIGS. 2c, 2d, respectively. FIG. 2c shows the groove 213′ in the A-side whose long opening been closed by the B-side 214 to form the microfluidic channel 213. FIG. 2d is a cross section through the integrated interconnect 220. As stated above, the inside surface 221 of the interconnect 220 can have screw threads or some other mechanical joining mechanism to accept a male part (not shown) that holds a capillary (not shown). A microfluidic channel extension 218 provides fluid communication between the interconnect opening 222, 224 and the microfluidic channel 213. The figures are not drawn to scale. Other shapes, angles, sizes, for openings, channels, etc are possible within the scope of the embodiments of the invention.

FIG. 3a is a photograph showing a perspective view of a system as described in FIG. 2. In addition, FIG. 3a shows standard male fittings 240 that can hold capillaries (not shown) that carry fluids to the channels 213 in the chip. The fittings 240 fit tightly into the interconnect ports 220. In some embodiments, there are complementary screw threads on the outside of the fittings 240 and on the inside of the ports 220. In one arrangement, the ports have ANSI standard internal 6-32 threads. FIG. 3b is a drawing showing some features of the microfluidic chip, according to an embodiment of the invention. One way in which the fitting 240 can join with a capillary 254 and with the interconnect port 220 can be seen.

It should be understood that the microfluidic chip systems shown in FIGS. 2 and 3 represent only portions of an overall microfluidic chip system that can have any number of channels and any number of ports.

In one embodiment, the need for careful alignment of the two portions 212, 214 prior to bonding is eliminated by designing the mold base so that all features including ports 220 and channels 213 are integrated in the top portion 212. The bottom portion 214 of the chip 210 is completely featureless. Another advantage of forming devices with integrated ports via injection molding is that the injection molding cycle time is independent of the number of ports in the chip. Therefore, the manufacturing technique is ideal for construction of high throughput microfluidic chips with any number of channels that have any number of interconnects. In one embodiment, the cycle time for manufacturing the A-side is between about 0.5 and 5 minutes. In one embodiment, the cycle time for manufacturing the A-side is between about 1 and 3 minutes. In one embodiment, the cycle time for manufacturing the A-side is approximately 2 minutes. The upper limit on interconnect density may be determined by the size of commercially available standard male fittings, as the ports are designed to accommodate standard fittings. In some arrangements, non-standard male fittings that are much smaller than the standard ones currently available can be used. Thus port density can increase, as the size of the ports can be decreased to accommodate the smaller fittings. In addition, the reversible nature of the connection facilitates burst pressure measurements, so that microfluidic chip users can have a better sense of the limitations of the chips instead of learning by trial and error, destroying experiments along the way.

In one embodiment of the invention, a microfluidic chip has a first approximately planar portion that has a first side with a groove and a second side with an integrated interconnect. There is an opening in the interconnect that provides fluid communication between the second side and the groove. There is also a a second approximately planar portion bonded to the first side of the first portion, thus sealing the groove to make a channel.

In another embodiment of the invention. a unitary microfluidic system has a first approximately flat piece and a second piece approximately parallel to the first piece. The two pieces are attached to one another. A microfluidic channel is embedded between the first piece and the second piece. There is a microfluidic channel extension that provides fluid communication between the microfluidic channel and the outer (unbonded) surface of the second piece. There is a protrusion on the outer surface of the second piece. The protrusion is approximately perpendicular to the second piece and an integral part of the second piece. The protrusion provides a fluid communication path between the microfluidic channel extension and the outside environment. In one arrangement, there are screw threads inside the protrusion along the fluid communication path. In one arrangement, the microfluidic chip is made of COC. In yet another arrangement, there are large surface area porous packing particles within the microfluidic channel.

In one embodiment, the microfluidic chip 210 as shown in FIG. 2 is fabricated in 2 pieces using an injection molding process. The top piece 212 includes interconnect ports 220, openings 222 through the ports 220, and grooves that define channels 213. The top piece 212 can have any size as desired and can include any number of interconnect ports 220 with openings 222 connected to any number of channel grooves 213. The bottom piece 214 is flat, approximately parallel-sided, and has about the same edge shape as the top piece 212. It is useful to have the edges of pieces 212 and 214 line up together during bonding and subsequent use.

In one embodiment of the invention, a method of making a unitary microfluidic chip, involves providing a mold base that has negative features to define interconnect protrusions and positive features to define openings in the interconnect protrusions, providing a mold insert that has positive raised features to define a layout of microfluidic channel grooves, assembling the mold base and the mold insert to form an A-side mold, injecting a liquid polymer into the mold, allowing the liquid polymer to solidify into an A side, releasing the A-side from the mold, providing an approximately planar B-side comprising a polymer and having approximately the same outer dimensions as the A-side, and bonding the B-side to the A-side to seal the microfluidic channel grooves into microfluidic channels. In one arrangement, the polymer is COC. In one arrangement, the bonding is done through thermal fusion. In another arrangement, the bonding is done through solvent bonding.

In an exemplary embodiment, chips are fabricated from cyclo-olefin copolymer (COC) pellets (Topas 8007×10, Ticona, Florence, Ky.) using a Roboshot 30α-I injection molding machine (FANUC America Corporation, Chicago, Ill.). A standard mold base (D-M-E Co., Madison Heights, Mich.) is machined and polished (Elmers Mold Polishing and Repair, San Marcos, Calif.) to a mirror finish for the production of optically clear parts. The mold base is maintained at 80° C. during production using thin film resistive heaters (Therm-X, Hayward, Calif.) that are customized to accommodate the ejector pins and mounted behind the A- and B-side mold plates. Insulating sheets (D-M-E, Madison Heights, Mich.) are positioned behind the mold plates in order to limit the thermal mass. Injection speed, packing, and other molding parameters are optimized for part quality and reduction of cycle time.

Replaceable mold inserts that are mounted directly on a mold base facilitates the rapid prototyping capability of injection molding. Since the inserts contain the channel layout that is transferred to the plastic, this technique allows nearly instantaneous change in the channel layout of the device through a simple replacement of the mold insert. However, the direct mounting of a microfabricated part in the mold cavity requires a very robust and mechanically strong insert that does not wear or deform after many cycles of the high pressure (>100 MPa), clamping force (30 tons), or temperature (250° C.) typical of an injection molding cycle. For this reason LIGA (A German acronym for lithography, electroforming and molding) and DEEMO (dry etch, electroplate, and molding) processes have been developed to produce tough metallic mold inserts. While these processes are widely used, they both suffer from problems such as production of highly stressed parts and long electroplating times.

Fabricating an electroform with low internal stress is very challenging, and several studies have focused on the development of techniques to minimize film stress during electrodeposition. Currently, the electroplating step is the bottleneck in the rapid-prototyping process that severely extends the turnaround time between design of channel layout and final device. To support the vision of rapid prototyping a mold insert fabrication process that eliminates the need for overplating, post plating planarization, and electroform film stress has been developed. The process steps for a typical DEEMO process are illustrated schematically in FIG. 4A. A silicon wafer 410 is coated with photoresist 412 and etched. Thin layers of titanium 414 and then nickel 416 are sputtered onto the structure. A much thicker layer of nickel 418 is then electroplated over the sputtered layers. Finally the silicon 410 is removed, leaving a titanium-coated nickel mold 420. The simplified LIGA process is illustrated in FIG. 4B and begins with spin coating a thick negative-tone resist onto a solid nickel wafer. After lithography, the substrate is electroplated with nickel to a thickness that corresponds to the desired height of the channel in the microfluidic chip that will be made from the mold. The resist is then stripped, affording a robust nickel mold 436. By starting with a solid metal wafer 432 that functions as the base, the need for overplating is eliminated and the thickness of the electroplated nickel film 434 can be reduced dramatically. In one embodiment, the electroplating process can be done in only 8 h to obtain a film 100 μm thick at a current density of 100 A/m². In another arrangement, the process is performed for between about 4 and 8 hours. Metals other than nickel and titanium can be used to make such a mold.

Feature uniformity is very important in order to obtain well-defined channels in a chip. To investigate the consistency of the cross-sectional geometry, a mold insert was diced along the channel in increments of 5 mm. An SEM image of a typical channel cross section is illustrated in FIG. 5B. The height and base lengths were recorded for each instance and plotted in FIG. 5A. Clearly, the trapezoidal cross section is maintained and the dimensions vary randomly within a tolerable amount along the entire length of the channel print. The standard deviation of H, W₁, and W₂ are 2, 6, and 4 μm, respectively. This represents another demonstration of the reliability of the process.

In an exemplary embodiment, a mold insert with positive raised features defining the cross sectional geometry and groove layout of the microfluidic channels was fabricated using a variation of the LIGA process. A nickel sheet 500 μm thick (UNS NO2200, National Electronic Alloy, Inc., Santa Ana, Calif.) is cut into 100 mm diameter discs using a wire electrical discharge machining (EDM). Next, the discs are thermally annealed at a reduced pressure of 94.5 kPa and oxygen-free atmosphere consisting of 20% hydrogen and 80% argon Annealing begins by heating the substrates from 200° C. to 1100° C. at 2° C./min. After 2 h at 1100° C., the disks are cooled to 200° C. at 2° C./min. The annealed substrates are then individually flattened by placement between two ground parallel steel plates in a Baldwin 400 kip universal testing machine. Flattening the discs requires straining them slightly beyond the yield stress, which is 185 MPa for annealed Ni 200. Next the disc surface is polished to a mirror finish by chemical mechanical polishing (CMP) performed with a slurry (Cabot Microelectronics, Aurora, Ill.) at 480 g/cm for 15 minutes using a pad and wafer rotation rate of 50 rpm on a conventional rotary tool. The final roughness of the surface of the substrates after CMP is 10 nm.

Adsorbed water is removed from the substrates by drying at 120° C. for 15 min, and organic contaminants are removed via an oxygen plasma de-scum (300 W, 48 Pa O₂, 15 min). A negative-tone photoresist (SU-8 2075, MicroChem Corporation, Newton, Mass.) is spin-coated on the substrate using a static dispense method. After allowing the puddle of resist (4 mL) to settle for 20 s, the resist is spread (500 rpm, 20 s, 1 krpm/s) to achieve a continuous resist coating over the substrate prior to the final spin step (1500 rpm, 20 s, 1 krpm/s) which yields a final film thickness of 150 μm. Following the pre-exposure bake (70° C., 5 min. 95° C., 20 min.) the substrate is allowed to cool for 10 minutes by natural convection. Flood exposure at 365 nm with a dose of 254 mJ/cm (SUSS MicroTec Inc., Waterbury Center, Vt.) is followed by a post-exposure bake at 70° C. for 1 min and at 95° C. for 10 min followed by 10 min cooling. Development is carried out at room temperature using SU-8 developer for 10 min. Finally, the substrates are thoroughly rinsed with isopropanol and water, dried and plasma cleaned as above. Contact hot plates were used for all heating steps in order to ensure reproducibility . . . . The 2-stage heating and 10 min are steps may be useful in minimizing resist cracking and delamination from the substrate.

A substrate is loaded into a custom made jig to isolate from the bath the regions of the substrate that are not to be plated. The jig-substrate assembly is then placed in a stirred Wood's strike (240 g/L NiCl₂.6H₂O and 160 g/L conc. HCl, 40° C.). A depolarized, soluble Ni anode (Alan Baker Co., South San Francisco, Calif.) is loaded in a canvas bag to prevent large particles of nickel from entering the solution. A constant current power supply (Keithley, Instruments Inc., Cleveland, Ohio) is used to maintain a current density of 100 A/m for 50 minutes, yielding a 5 μm layer of active nickel on regions of the substrate as desired. After 50 minutes the power supply is turned off and the jig-substrate assembly is removed carefully to ensure that a puddle of bath solution remains over the active area. Liquid seems to prevent development of nickel oxide which is suspected to be responsible for poor adhesion between substrate and electrodeposited film. After displacing the puddle from the wafer surface with deionized water the jig-substrate assembly is finally placed in the electroplating bath.

A layer of 100 μm Ni is electrochemically deposited at a current density of 100 A/m² in a ready-to-use nickel sulfamate electroplating bath (Technic, Inc., Anaheim, Calif.). The heating element enclosed in a quartz sheath (Cole Parmer, Vernon Hills, Ill.) is controlled with a fuzzy PID controller to maintain the bath temperature at 40° C. Simulatneous agitation and filtering is achieved using a pump fitted with a filter at the inlet (Flo King, Longwood, Fla.). The pump effluent is directed toward the center of the active plating area. The thickness of the electroplated layer was found to closely follow that calculated using Faraday's Law.

$$x = \frac{1}{ρ} \frac{m}{q} \frac{I}{A} t \qquad ( 2 )$$

where x is the film height, ρ is the density of nickel, I is the plating current, A is the surface area plated, and m and q are the mass and charge of one of mole of nickel, respectively.

After electroplating, the photoresist is stripped for 4 h at 80° C. in a bath of SU-8 Remover (MicroChem). The substrate is then rinsed with isopropanol and water and then coated with a 8 μm layer of positive tone photoresist to protect the structures from being damaged by small particles generated during dicing. A dicing tool (Disco Hi-Tec America Inc., Santa Clara, Calif.) is used to make aligned cuts, yielding a mold insert with channel termination points or pads precisely aligned to the access holes on the mold base of the injection molding tool.

Bonding polymer substrates together to hermetically seal the channel with minimal distortion of micrometer-scale features is a very challenging issue that has received considerable attention. The A-side has open grooves that define the layout of the microfluidic channels. When the A-side is bonded to the B-side, the B-side provides the remaining side that closes the grooves into tubular channels. “Sealing the channel” is used here to mean providing the remaining side that closes the grooves into tubular channels. In an ideal case, the groove undergoes no changes in its shape and size; the B-side merely provides the additional surface that transforms the tube into a channel. The importance of this fabrication step has led to the development of several bonding techniques ranging from simple thermal fusion, gluing, lamination, and solvent bonding to more elaborate methods such as laser welding, microwave welding, and resin-gas injection. In order to ensure that subsequent microfluidic analysis is not perturbed by the microfluidic chip, it is useful to maintain the chemical homogeneity of all channel walls.

In one embodiment, the A and B sides of the chip are bonded together by thermal fusion. A hydraulic press (Carver, Inc., Wabash, Ind.) fitted with heated plates and an analog load gauge is used to thermally bond the chips. Customized Pyrex™ bonding plates were made to accommodate the protruding ports of the chip during the bonding process. The bonding time, temperature, and pressure were varied and the burst pressure was measured for each set of bonding conditions (Table 1). Although the burst pressure is not a direct measure of the bond energy at the interface, it is a valuable engineering parameter that sets the upper limit for device operation.

TABLE 1
Bonding parameters for each bonding condition.
Each bonding condition was repeated 10 times.

| Trial | Temperature [C.] | Pressure [MPa] | Time [min] | Yield [%] |
|---|---|---|---|---|
| 1 | 80 | 0.47 | 15 | 70 |
| 2 | 80 | 0.47 | 10 | 80 |
| 3 | 80 | 0.71 | 10 | 90 |
| 4 | 90 | 0.24 | 30 | 20 |
| 5 | 90 | 0.28 | 10 | 70 |
| 6 | 90 | 0.36 | 10 | 80 |
| 7 | 95 | 0.28 | 10 | 30 |

The burst pressure is measured using chips containing a single channel and two I/O ports. After pumping water into the chip for two minutes, the outlet port is plugged with a standard fitting and the back pressure is recorded. FIG. 6 shows the internal pressure build-up and sudden failure observed in a typical burst pressure measurement. The results of burst pressure measurements for each bonding condition are presented in FIG. 7. They indicate that the bonding temperature has the most significant effect on bond strength. Bonding at 80° C. yields chips bursting at less than 5 MPa, while there is an approximately 2-fold improvement in bond strength at temperatures of 90 and 95° C. These temperatures are well above the glass transition temperature (Tg) of the material, Topas 8007×10, which is measured to be 80° C. by dynamic scanning calorimetry. The strength of the bond achieved by thermal fusion results from chain entanglement of polymer chains located at the surface of the two parts constituting the chip. The chain mobility and therefore their ability to penetrate across the interface is much higher at a temperature above the glass transition. In contrast, bonding pressure seems to have a lesser effect once sufficient pressure is applied to bring the pieces into intimate contact to facilitate chain entanglement. Similarly, although holding the pieces together for a period of time long enough to effect a bond is useful, but additional bonding time appears to have only a very small impact.

FIG. 6 is a plot of pressure vs. time for chips bonded at a temperature of 95° C. and a pressure of 0.28 MPa for 10 min. As illustrated in FIG. 6, the chips exhibit very good resistance to pressure. The chips start to leak at an in-channel pressure of over 12 MPa and burst at 15.6 MPa, which is the highest operational back-pressure of any microfluidic device reported to date. The ability of the chips to sustain such high pressures without leakage or break demonstrates clearly the advantage of integrated interconnects, i.e., a unitary microfluidic chip/interconnect system.

In another embodiment, with reference to FIG. 2, the portions 212, 214 of the microfluidic chip are bonded together using a solvent bonding process. The top surface 208 of the bottom portion 214 is exposed to cyclohexane for between about 60 and 150 seconds. In other arrangements, solvents such as hexane, dichloromethane, or toluene can be used. The surface 208 is exposed to the solvent by holding it in the vapor. The solvent-exposed top surface 208 of the bottom portion 214 is then pressed against the bottom surface 209 of the top portion 212 and a load is supplied. In one arrangement, each surface 208, 209 has an area of approximately 20 square cm, and the applied load is approximately 680 kg. The load is applied for approximately 3 minutes. Heavier loads and longer bonding times (i.e., longer periods of load application) can also be used. It is useful to wait at least approximately 5 minutes before using the chip for microfluidic analysis to ensure that all solvent vapor has dissipated. FIG. 8 shows a graph of maximum burst pressure for solvent-bonded chips. It is interesting to note that neither the chips nor their integral ports failed during this test. The test ended when the capillary popped out of the fitting at 37.5 MPa. The male fittings used are rated at 34.5 MPa or 5,000 psi.

FIG. 9 is a graph showing burst pressure data from both thermally bonded and solvent bonded microfluidic chips, according to embodiments of the invention.

Devices designed for biomedical analysis are asked to perform standard processes such as sample preconcentration, enzymatic digestion, and separation; all of which rely on interaction between the analyte located in the mobile phase and the surface of a solid stationary phase. However, the vast majority of microfluidic devices use open channels that have a small ratio of surface area to channel volume. Because of the limited surface area available for interaction characteristic of such open channel configuration, very long channels are often used to increase the amount of surface with which an analyte can come into contact. Although long microfluidic channels can be arranged in a small area by adopting a folded channel configuration, the concomitant turn-induced band broadening severely hinders separation resolution. While dispersive spreading in turns can be corrected by modulating turn geometry, filling the channels with porous materials that increase surface area has the potential to reduce the required channel length by at least two orders of magnitude.

For decades, chemical engineers have designed macroscale processes that rely on high surface area porous packing materials to conduct a variety of processes including catalysis, adsorption, and separations. Excellent control over the porous and chemical properties of particulate materials in conjunction with a thorough understanding of transport phenomena in packed beds have led to application of this technology to a microfluidic format. Unfortunately, attempts to increase the surface area of microfluidic channels by packing them with porous particles have not given fully satisfactory results.

In one embodiment of the invention, surface area is increased within the channel with the preparation of a continuous porous polymer monolith that is covalently attached to channel walls. UV light can be used to initiate polymerization reactions directly within the microfluidic channels. Thus a simple mask can be used to define the exact location of the monolith. In situ preparation of the monolith begins with injecting a liquid polymerization mixture containing photoinitiator, monomers and porogens into the channel. Upon irradiation with UV light, the photoinitiator initiates free-radical polymerization exclusively in the exposed regions.

If the wall of the channel is not chemically modified for covalent attachment, shrinkage of the monolith during polymerization may lead to void space at the monolith-wall interface. Obviously, any liquid would flow through the large voids exhibiting much lower resistance to flow than the porous polymer. This undesired flow can be avoided by covalently attaching the monolith to the channel wall during the polymerization. Thus a method has been developed to effect covalent anchoring of the monolith to the polymer substrates by photoinitiating polymerization reactions directly from the channel wall. This approach includes controlled photografting of the walls with ethylene diacrylate, which creates a thin layer of polymer with a multiplicity of pendant acrylate groups. These polymerizable vinyl-containing moieties are then incorporated into the monolith during its in situ preparation and anchor it to the wall. As illustrated in FIG. 10C, a channel has been modified to produce a layer about 400 nm thick.

In an exemplary embodiment a monolith was prepared within a COC microfluidic chip using a polymerization mixture containing butyl methacrylate, ethylene dimethacrylate, decanol and 2,2-dimethoxy-2-phenyl-acetophenone. Subsequent photopolymerization was carried out through a mask. FIG. 10 shows the monolith at various magnifications. The SEM micrographs reveal the globular structure of the monolith with a globule size of about 2 μm as well as large pores among clusters of these globules.

In another exemplary embodiment, methyl methacrylate (99%, MMA), n-butyl methacrylate (99% BuMA), ethylene dimethacrylate (99%, EDMA), ethylene diacrylate (99%, EDA), 2,2-dimethoxy-2-phenylacetophenone (99%, DMPAP), benzophenone (99.9% BP), cyclohexanol, and 1-dodecanol are used to prepare a monolith within the channel of a plastic microfluidic chip. The MMA, BuMA, and EDMA are vacuum distilled and all other chemicals are used as received.

The channel surface is first grafted with an adhesion layer of polymer as follows: a mixture of 0.485 g MMA, 0.485 g EDA, and 0.030 g BP is purged with nitrogen for 10 min and then pumped into the bonded chip using a gas tight 100 μL syringe (Hamilton Company, Reno, Nev.). The chip is then irradiated with the DUV light source (Optical Associates Inc., San Jose, Calif.) for 4 min, and subsequently flushed with several channel volumes of methanol.

The surface modified channel is filled with a polymerization mixture comprised of 0.400 g EDMA, 0.600 g BuMA, 1.500 g 1-decanol, and 0.01 g DMPAP that has been purged with nitrogen for 10 min. Irradiation for approximately 10 min and subsequent washing with methanol afford a monolith with a pore size of 2.2 μm as measured using mercury intrusion porosimetry.

UV transparency is critical to the successful preparation of a porous polymer monolith directly within the channel of the chip via photoinitiated polymerization. Because wide variation in optical properties between samples from different vendors and even among samples from the same vendor have been reported, both the UV transparency and autofluorescence of all commercial grades of COC currently available have been measured and normalized. The major source of variation among grades may be various types and levels of small molecule additives such as flame-retardants, smoke suppressants, lubricants, antioxidants, and UV absorbers that are often benzophenone derivatives designed to mitigate UV-induced material damage. These additives are routinely added to commercial polymers to improve their processability and extend lifetimes.

In one embodiment, the photoinitiated reactions leading to surface modification of the channel wall for covalent attachment of the monolith can use DUV light with a wavelength near 250 nm while the subsequent preparation of the monolith is carried out using near UV irradiation (λ=300-400 nm). A high level of autofluorescence has also been observed for most polymers. This can be a barrier to the universal transition from glass to plastic microfluidic devices because it significantly reduces the sensitivity of detection by LIF. Autofluorescence of selected COC materials seems to vary considerably. Again, additives are the most probable source of the variation in autofluorescence.

Based on their low autofluorescence and high DUV transmission Topas 8007×10 from Ticona and Zeonex 480 from Zeon chemicals have been identified as strong candidates for chip production. Despite its slightly larger autofluorescence, the Ticona polymer is chosen for chip production because its lower Tg (80° C. versus 138° C.) reduces the heat used for injection molding and chip bonding. However, grade 480 from Zeon may be a more suitable material for fabricating devices with integrated heaters or for performing on-chip reactions such as polymerase chain reactions (PCR) for DNA amplification that require elevated temperatures.

Another material property that is important for the in situ preparation of monoliths is oxygen permeability. The high O₂ permeability of PDMS, ˜10³ Barrers compared to 0.4 Barrers for COC, works against the use of a monolith within a chip made of PDMS. Polymerization reactions that lead to surface modification of channel wall and in situ monolith formation are usually photoinitiated and proceed by a free radical mechanism that is inhibited by the presence of dissolved oxygen. For this reason it is useful to use chip substrates that have a low permeability to oxygen.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

### BRIEF DESCRIPTION OF THE DRAWINGS

The figures are for illustrative purposes only and are not drawn to scale.

FIGS. 1a, 1b, 1c, 1d show a prior art microfluidic chip system.

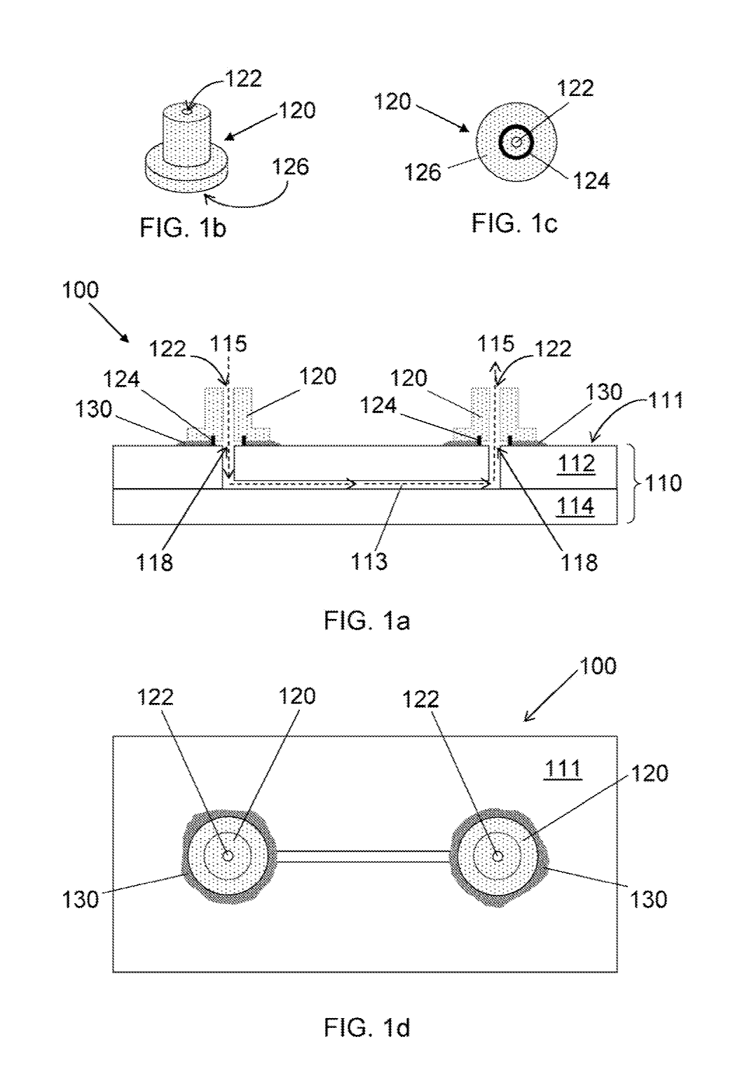

FIGS. 2a, 2b, 2c, 2d show a microfluidic chip system, according to an embodiment of the invention.

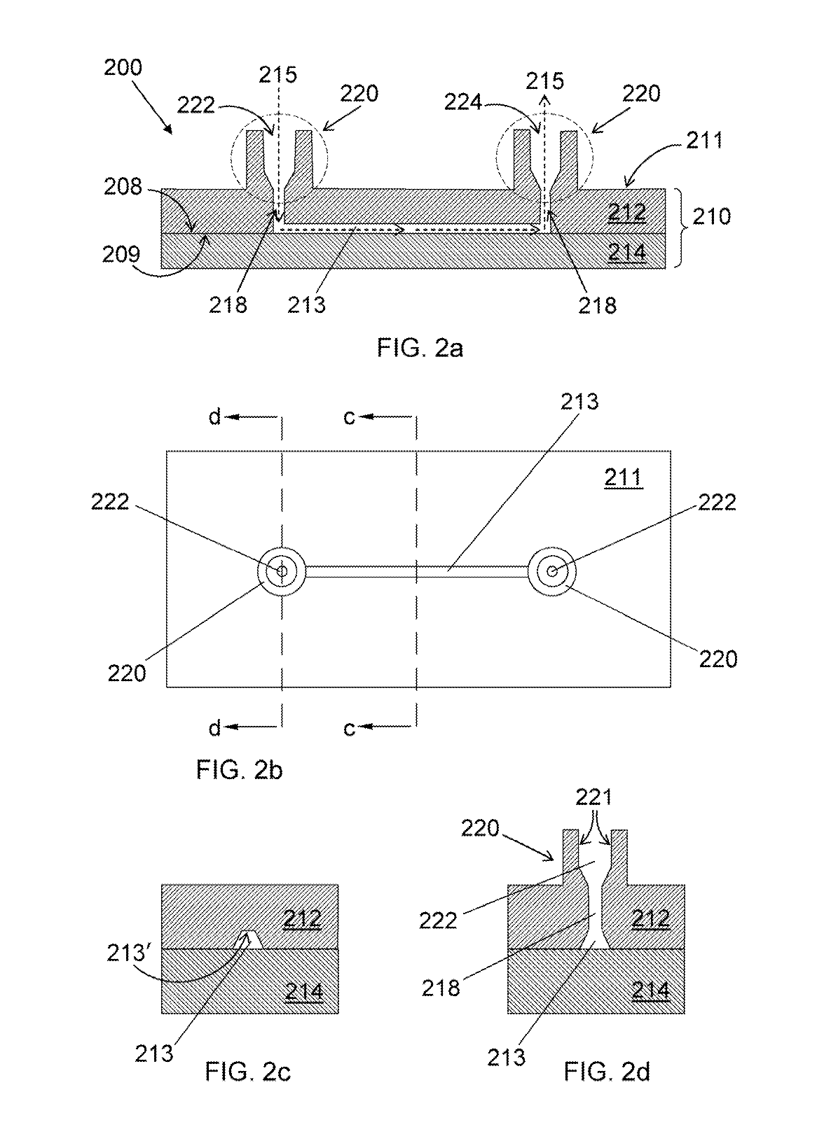

FIG. 3a, 3b show features of the unitary microfluidic chip, according to embodiments of the invention.

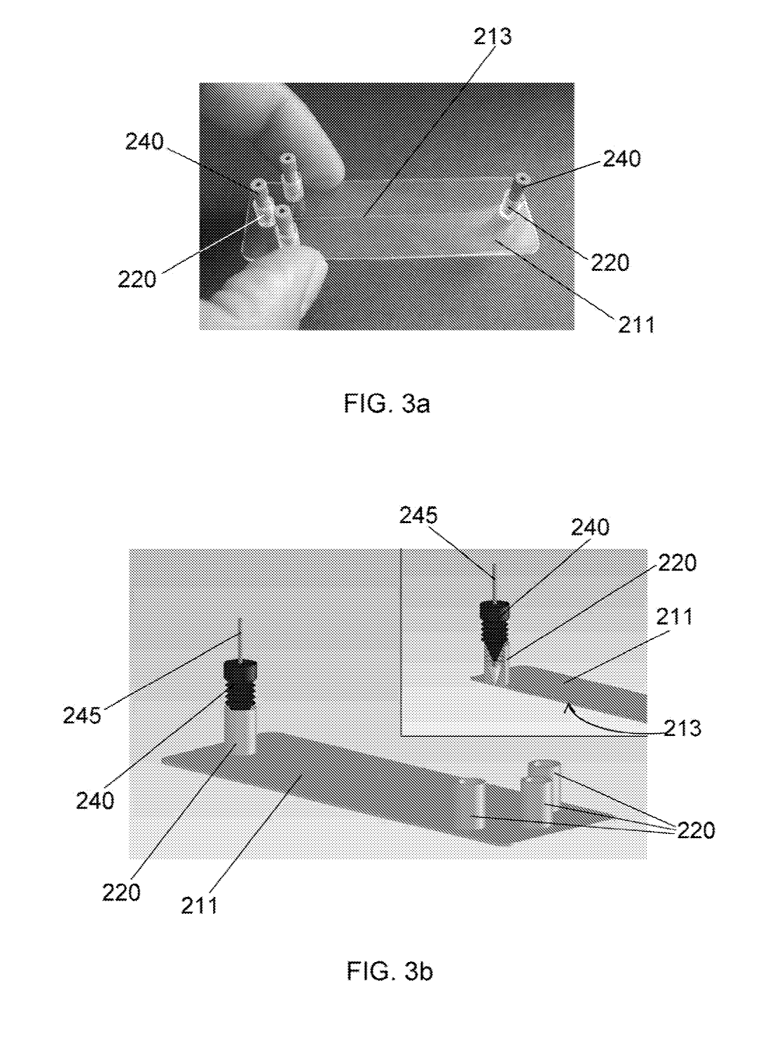

FIG. 4 shows the steps involved in fabrication of a mold insert by the DEEMO process (A) and by a simplified process (B), according to an embodiment of the invention.

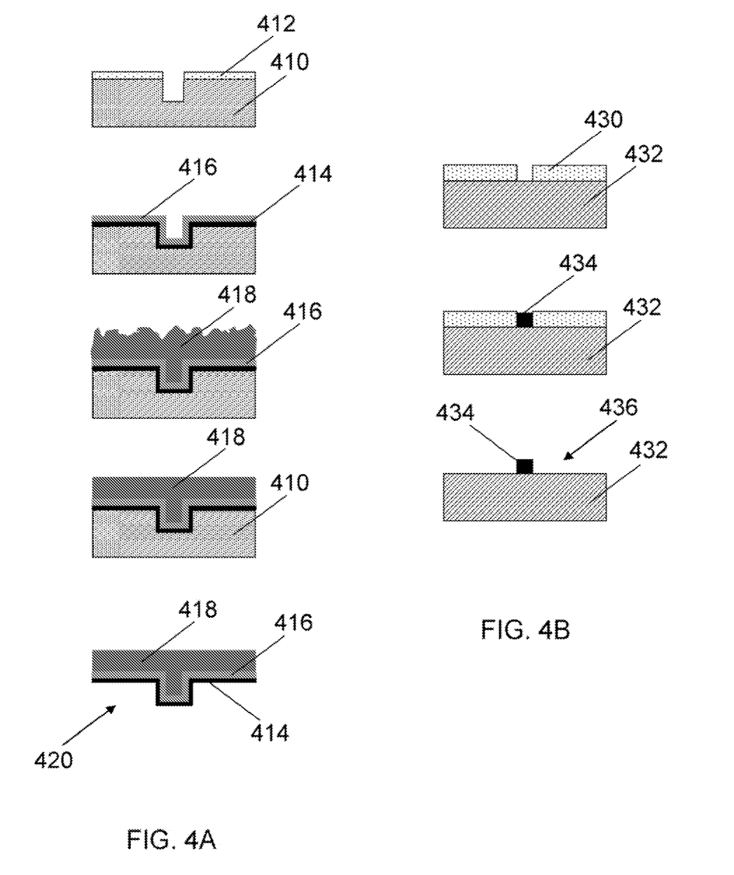

FIG. 5a shows cross sectional dimensions of a mold insert at various distances along the channel. FIG. 5b is an SEM image of a typical cross section of a mold insert.

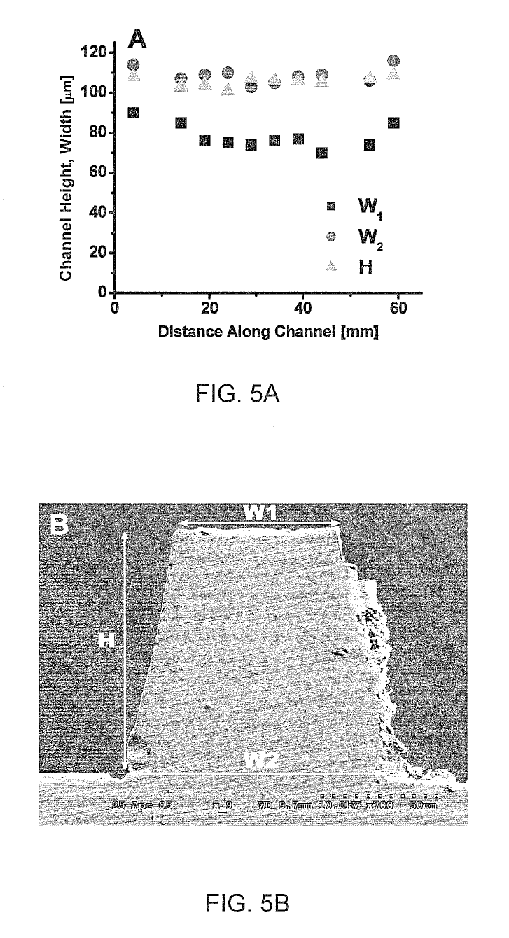

FIG. 6 shows pressure build-up and sudden failure inside a chip bonded using condition 7 in Table 1.

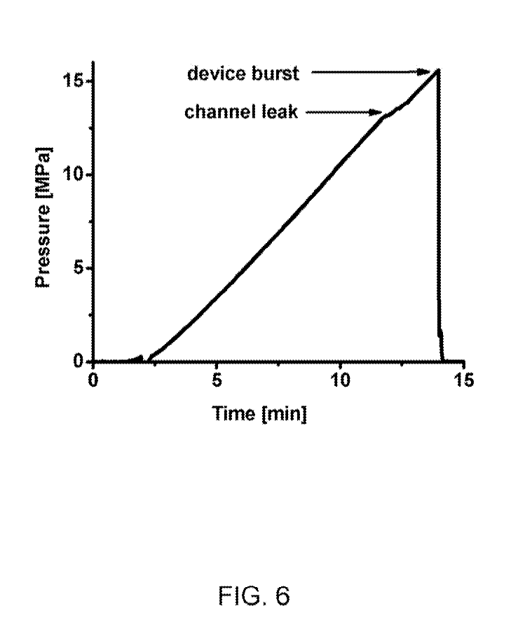

FIG. 7 shows burst pressure for bonding conditions specified in Table 1.

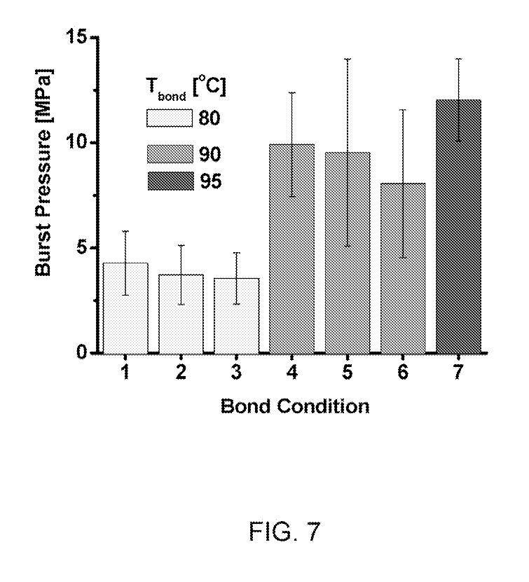

FIG. 8 shows burst pressure for solvent bonded microfluidic chips, according to an embodiment of the invention.

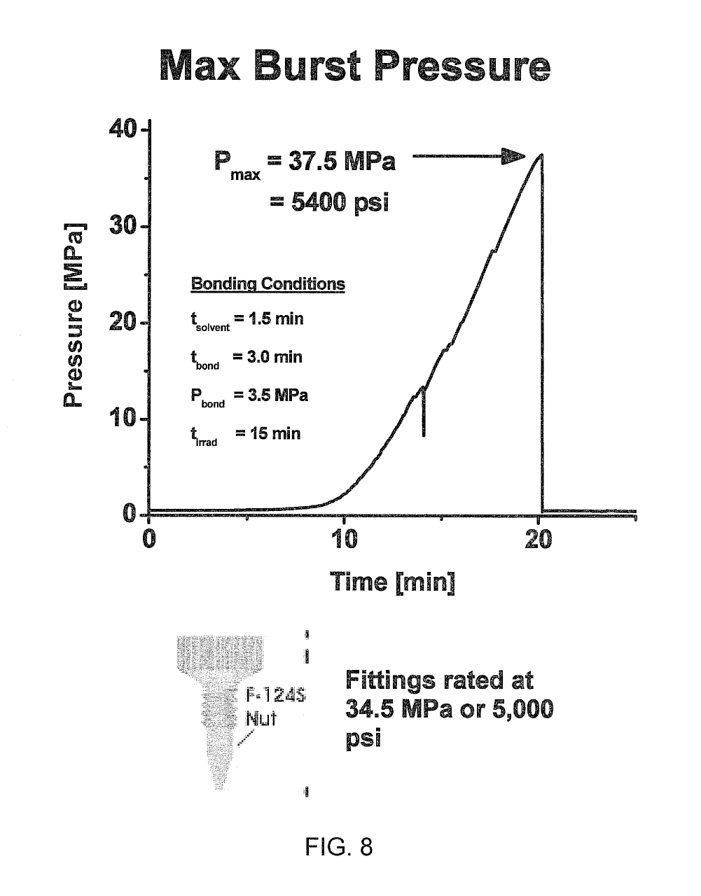

FIG. 9 is a graph showing burst pressure data from both thermally bonded and solvent bonded microfluidic chips, according to embodiments of the invention.

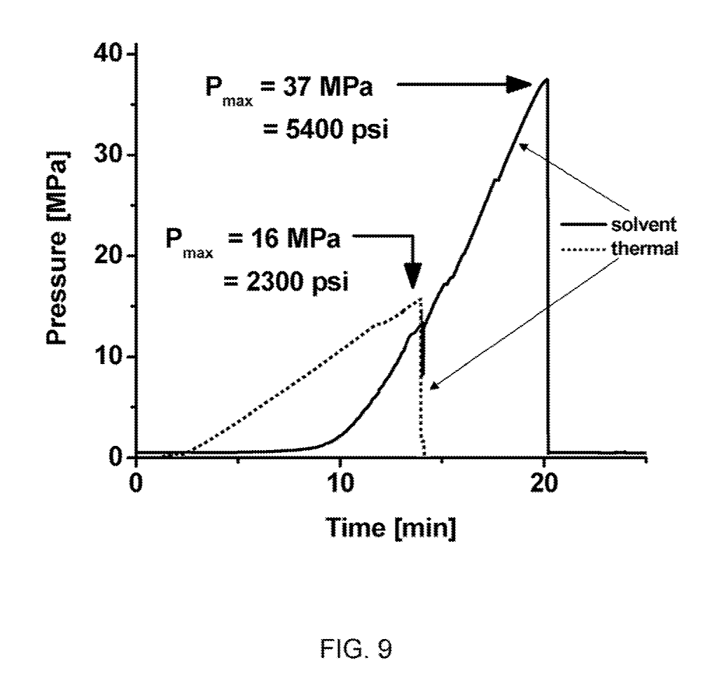

FIG. 10 shows cross sectional SEM images of a microfluidic channel containing monolith covalently attached to wall taken at magnifications of 600×(A), 2,000×(B), and 10,000×(C).

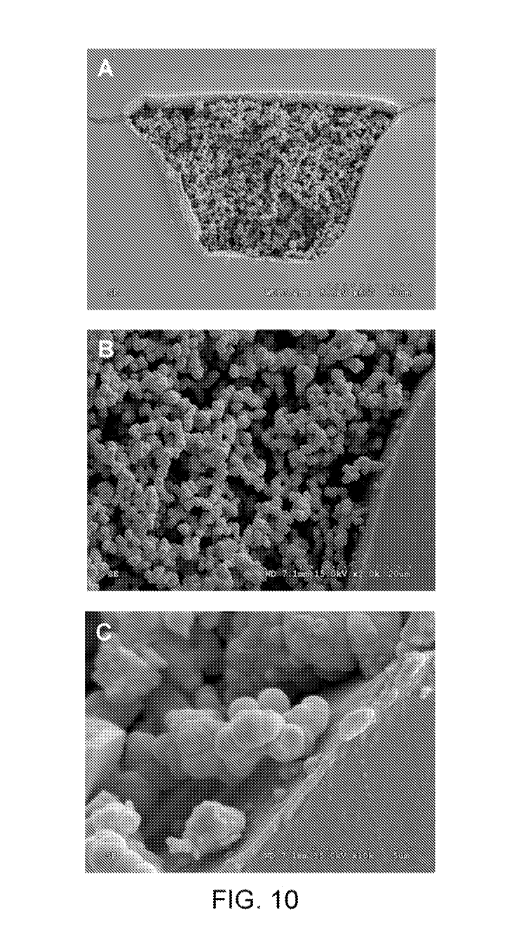

### INDUSTRIAL APPLICABILITY

A microfluidic chip that can be manufactured quickly, cheaply, and is ready-to-use with no need for further assembly can open up new possibilities in microfluidic applications. The chip can be used reversibly with high liquid pressures and can even employ high surface area porous packing materials in its channels so that a wide variety of processes, including catalysis, adsorption, and separations, can be performed easily within the microfluidic system.

We claim:

1. A microfluidic chip, comprising:
a first approximately planar portion, comprising:
a first side with a groove;
a second side with an integrated interconnect, through which interconnect is an opening that provides fluid communication between the second side and the groove;
a second approximately planar portion bonded to the first side of the first portion, thus sealing the groove to make a channel.

2. A unitary microfluidic system, comprising:
a first approximately flat piece;
a second piece approximately parallel to the first piece and attached to the first piece;
a microfluidic channel embedded between the first piece and the second piece;
a microfluidic channel extension providing fluid communication between the microfluidic channel and an outer surface of the second piece;
a protrusion on the outer surface of the second piece, the protrusion approximately perpendicular to the second piece and an integral part of the second piece, the protrusion comprising a fluid communication path between the microfluidic channel extension and the outside environment.

3. The system of claim 2, further comprising screw threads inside the protrusion along the fluid communication path.

4. The system of claim 2 wherein the microfluidic chip comprises COC.

5. The system of claim 2, further comprising large surface area porous packing particles within the microfluidic channel.

6. A method of making a unitary microfluidic chip, comprising the steps of:
providing a mold base that has negative features to define interconnect protrusions and positive features to define openings in the interconnect protrusions;
providing a mold insert that has positive raised features to define a layout of microfluidic channel grooves;
assembling the mold base and the mold insert to form an A-side mold;
injecting a liquid polymer into the mold;
allowing the liquid polymer to solidify into an A-side;
releasing the A-side from the mold;
providing an approximately planar B-side comprising a polymer and having approximately the same outer dimensions as the A-side; and
bonding the B-side to the A-side to seal the microfluidic channel grooves into microfluidic channels.

7. The method of claim 6 wherein the polymer is COC.

8. The method of claim 6 wherein bonding step comprises thermal fusion.

9. The method of claim 6 wherein bonding step comprises solvent bonding.
